(19) United States
(12) Patent Application Publication
(10) Pub. No.: US 2026/0222956 A1
(43) Pub. Date: Jul. 30, 2026

(54) TECHNIQUES FOR OPTIMIZING GATEWAY SELECTION ON A CELLULAR NETWORK

(71) Applicant: T-Mobile USA, Inc., Bellevue, WA (US)

(72) Inventors: Kunal Prakash Barawkar, Bothell, WA (US); Rushabhkumar Patel, Newcastle, WA (US); Suresh Thanneeru, Redmond, WA (US)

(21) Appl. No.: 19/038,441

(22) Filed: Jan. 27, 2025

(51) Int. Cl. H04W 36/14; H04W 36/00; H04W 36/30; H04W 88/16

(52) U.S. Cl. CPC H04W 36/14; H04W 36/0044; H04W 36/304; H04W 88/16

(57) ABSTRACT

Techniques are described herein for optimally allocating a collocated gateway to a user equipment upon that user equipment switching between access networks. In embodiments, such techniques may comprise determining, by a Mobility Management Engine (MME) of a first access network, that a user equipment is to connect to the first access network. Upon determining that the user equipment is currently registered with a second access network, the techniques may comprise receiving, from the second access network, context data related to a current registration of the user equipment, generating priority data based on the context data, and assigning, to the user equipment, a gateway selected based on the priority data.

### BACKGROUND

Cellular networks continue to evolve as they adopt new technologies. Most recent is the adoption of the fifth-generation (5G) technology standard for broadband cellular networks. However, while 5G provides significant benefits over older technology standards, costs of upgrading user equipment and difficulties in implementing technologies across a large network mean that many existing user equipment and even portions of cellular networks continue to operate using legacy technology, such as Long-Term Evolution (LTE) technology as outlined in the fourth-generation (4G) technology standard.

Today's cellular communications generally employ radio access networks (RANs) as well as one or more public data networks (PDNs). User equipment (UE) such as mobile telephones and other devices connect to a RAN, and the RAN forwards communications between the UE and the PDN. Since cellular networks must often be configured to provide service using new technologies as well as legacy technologies, a UE may have access to multiple RANs that can be used to access a single cellular network. For example, a UE may be in wireless communication range of a first RAN that operates on the 5G technology standard as well as a second RAN that operates on the 4G technology standard. In such cases, a UE may be capable of switching between the two RANs as necessary (e.g., as one RAN becomes unavailable) in order to receive continuous service.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example network architecture for a system in which a network is capable of servicing user equipment using a number of different access technologies in accordance with embodiments.

FIG. 2 illustrates a cellular network that includes a combined communication system in accordance with some embodiments.

FIG. 3 depicts a block diagram illustrating a process for generating priority data and assigning a gateway device based on that priority data in accordance with embodiments.

FIG. 4 depicts a block diagram illustrating a process for performing a handover between access networks for a user equipment in accordance with embodiments.

FIG. 5 depicts a flow diagram illustrating an exemplary process for performing gateway selection during a handover event in accordance with at least some embodiments.

FIG. 6 shows an example computer architecture for a computing device capable of executing program components for implementing the functionality described above.

### DETAILED DESCRIPTION

Techniques for packet core network (PCN) selection of collocated gateways are disclosed herein. PCN gateways including serving gateways (SGWs) and packet gateways (PGWs) can be selected according to the disclosed techniques to enable network access for user equipment.

Gateway selection techniques according to this disclosure can be initiated in response to a network access request by user equipment such as a mobile telephone, or any number of devices (computers, televisions, internet of things (IOT) devices, etc.) that may connect via a home or office internet connection, or any other device. For example, a user equipment may send a fourth generation (4G) type network access request to a radio access node, such as an e-node B (eNB) type radio access node. In some cases, the techniques may be performed when a user equipment switches between access network types (e.g., when the user equipment switches from a 5G access network to an LTE access network and vice versa).

In embodiments, during a handover procedure in which a user equipment (UE) is switched from operating on a first access network to operating on a second access network, rather than make a gateway selection based on a location associated with the current data plane, a computing device associated with the first access network can provide priority data (in context data) that provides the ability for the new access network to more optimally allocate a gateway device to the UE. In embodiments, the priority data allows the new access network to select the most optimal gateway device that is capable of meeting QoS requirements associated with services required by the UE.

Embodiments of the disclosure provide for a number of advantages over conventional systems. For example, embodiments of the disclosed system allow for more optimal selection of gateway devices to be assigned to user equipment when that user equipment switches between different access network types. Notably, the embodiments of the disclosed system allow for selection of a gateway device that is collocated with the user equipment in order to meet service level agreement requirements associated with the user equipment. For example, assignment of a collocated gateway to the user equipment may minimize latency for that user equipment.

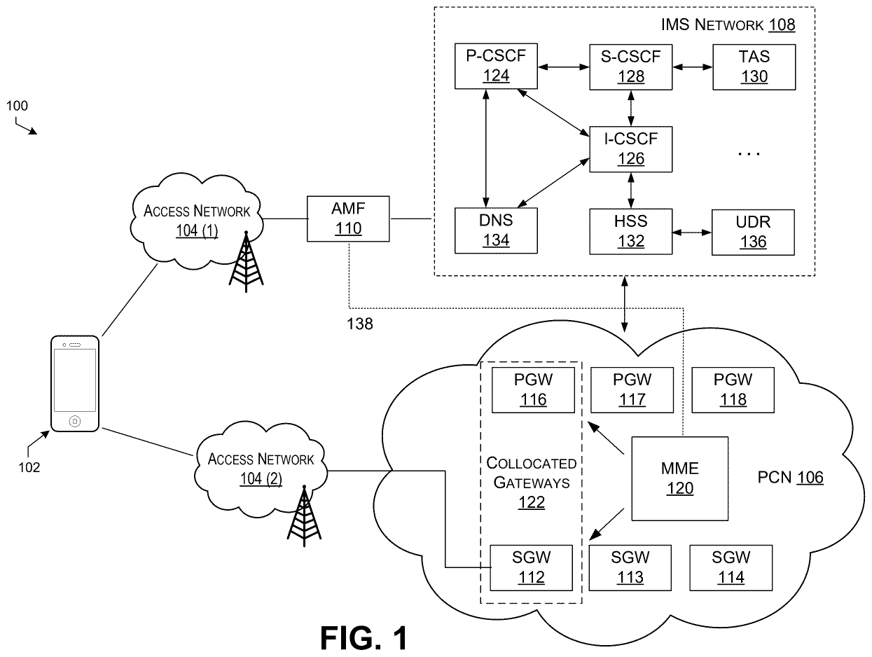

FIG. 1 illustrates an example network architecture 100 for a system in which a network (e.g., a cellular network) is capable of servicing user equipment using a number of different access technologies in accordance with embodiments. The architecture 100 may include a user equipment (UE) 102 capable of connecting to one or more access networks 104 in order to communicate with a packet core network (PCN) 106 and/or an IP multimedia subsystem (IMS) network 108.

In embodiments, a UE 102 connecting to the system may be capable of doing so using access networks that operate with different access technologies. For example, the UE 102 may be capable of connecting to both an access network 104(1) and an access network 104(2), where both of the access networks 104(1) and 104(2) can provide ingress/egress to the system but operate using different technology standards. For example, access network 104 (1) may operate using a 5G technology standard, whereas access network 104 (2) may operate using a 4G technology standard.

The access networks 104(1) and 104(2) may be compatible with one or more radio access technologies, protocols, and/or standards, such as 5G NR technology, LTE/LTE Advanced technology, other Fourth Generation (4G) technology, High-Speed Data Packet Access (HSDPA)/Evolved High-Speed Packet Access (HSPA+) technology, Universal Mobile Telecommunication System (UMTS) technology, WiMAX technology, Wi-Fi technology, and/or any other previous or future generation of radio access technology. Likewise, the access network may use any suitable cellular communications protocols, including a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a New Radio (NR) protocol, and the like.

The access networks 104(1) and 104(2) may include various types of base stations, for example, 2G base stations and/or 3G NodeBs that are associated with GSM and CDMA access networks, e-node Bs (eNBs) that are associated with an LTE access network also known as an Evolved UMTS Terrestrial Radio Access Network (E-UTRAN), or gNBs or new radio (NR) base stations that are associated with a 5G access network. In some cases, even when the access networks 104 (1 and 2) operate using different technology standards, both of those access networks may be implemented within a single base station.

In embodiments, each of the access networks 104 (1) and 104 (2) may operate using a different technology standard. For example, the access network 104 (1) may operate using a 5G technology standard whereas the access network 104 (2) may operate using a 4G technology standard. In such embodiments, both access networks 104 (1 and 2) may be available to the UE 102. The UE 102 may prioritize the 5G connection and may initially connect to the PDN via the access network 104 (1). However, the access network 104 (2) may become unavailable (e.g., oversubscribed, disconnected, or otherwise unavailable) at a later time and the UE 102 may automatically switch its connection to the access network 104 (2). In the architecture 100, an access network 104 (1) operating using a 5G technology standard may connect to the PDN via a node that provides an Access and Mobility Management Function (AMF) 110. In contrast, an access network 104 (2) operating using a 4G technology standard may connect to the PDN via a PCN 106.

An AMF 110 handles registration of the UE 102 within a 5G network. The AMF 110 performs authentication services for the UE 102 and authorizes its access to 5G services. In addition, the AMF 110 may track location data for the UE 102 and manages its mobility (e.g., handoffs) within the 5G network. Note that while architecture 100 depicts only an AMF 110 in communication with access network 104 (1), the 5G network would include a number of other components for providing functionality that are not shown.

A PCN 106 may include selectable gateway components, such as serving gateways (SGWs) 112, 113, 114, and packet gateways (PGWs) 116, 117, 118, which can be selected for use in connection with user equipment (UE) 102 network access. PCNs may generally be operated by cellular communication network operators, such as T-MOBILE® and others. A PCN 106 can manage UE communications, for example by serving as an intermediary between the UE and other network entities and endpoints, such as the IMS network 108.

Evolved packet core (EPC) is a PCN framework for providing converged voice and data services on a fourth generation (4G) long-term evolution (LTE) cellular network. EPC comprises several network nodes which handle traffic and provide functions such as session management, mobile management, authentication and quality of service (QoS). Some of the primary nodes in EPC are the mobility management entity (MME) 120, the serving gateway (SGW), the packet gateway (PGW), the policy and charging rules function (PCRF), and the home subscriber service (HSS). The PCN 106 can comprise, e.g., an EPC type PCN including various components according to the EPC architecture, many of which are omitted from FIG. 1 for simplicity.

The MME 120 is the control plane node of the PCN 106 and is located at its edge. The MME 120 manages user equipment session states and authenticates and tracks user equipment. The MME may communicate with one or more components of the IMS network 108, such as a home subscriber service (HSS) node for user equipment authentication. The MME's mobility function enables user equipment to access the network. Among its other functions, the MME selects gateways such as the SGW and the PGW to enable cellular communication service for each connecting user equipment.

The PCRF supports data flow detection, policy enforcement and flow-based charging. The PCRF also manages QoS and defines charging based on user subscriptions are applicable to user equipment. The PCRF ensures that users receive services and are charged for them according to their contracts.

A SGW is a user plane node which handles user data traffic. The SGW connects to a RAN (e.g., access network 104(2)) and routes internet protocol (IP) data packets through the RAN to the core network. The separation of the control plane provided by the MME and the user plane provided by the SGW usefully allows separation between user data and control/signaling data.

A PGW may also be referred to as a packet data node gateway or a packet data network gateway. The PGW serves as the interface between the PCN 106 and other packet data IP networks, such as the Internet. The PGW may also manage Quality of Service (QoS) attributes for the connection with the UE 102 and allocate IP addresses to the UE 102.

Illustrated components of the PCN 106 comprise an MME 120 which can be configured according to this disclosure to select collocated gateways 122, e.g., the SGW 112 and the PGW 116, to enable network access of a UE 102 under circumstances wherein collocated gateways 122 are preferred or required for a UE 102, as described herein. The MME 120 can also operate in a manner that allows selection of other gateways, e.g., SGWs 113, 114, or PGWs 117, 118, for other UEs, for which collocated gateway selection may not be preferred or required.

The IMS network 108 may include multiple components that function together to deliver multimedia communications services such as voice, video and text messaging over an IP network, e.g., PCN 106. For example, the IMS network 108 may include a proxy call session control function (P-CSCF) node 124, an interrogating call session control function (I-CSCF) node 126, a serving call session control function (S-CSCF) node 128, a telephony application server (TAS) 130, a home subscriber server (HSS) 132, a domain name server (DNS) 134, and a user data request function (UDR) 136.

A P-CSCF node 124 node is a proxy device that acts as a first point of contact for UE 102 within the IMS Network 108. Each UE is assigned to a respective P-CSCF when it is registered with the IMS Network. A P-CSCF node can receive, via a communications interface, a Session Initiation Protocol (SIP) request from the UE 102 to be forwarded to a S-CSCF.

A S-CSCF node 128 node is the central node of the signaling plane and sits on the path of all signaling messages to/from a UE 102 that is assigned to it. There can be multiple S-CSCFs in the network for load distribution and high availability reasons. A S-CSCF is typically assigned to a user (or UE) by a Home Subscriber Server (HSS), when it's queried by the I-CSCF.

A S-CSCF node 128 may represent one of multiple available S-CSCF nodes that is chosen (or otherwise selected) for assignment to the UE 102. S-CSCF nodes, such as the S-CSCF node 128, are sometimes referred to as “Registrars,” and the process of allocating Registrars among users who are registering for IMS-based services is sometimes referred to as finding a “home CSCF” for the UE 102.

A I-CSCF node 126 is a SIP function node that acts as a forwarding point for external devices. The I-CSCF node 126 queries the HSS to determine S-CSCF node/UE mapping and forwards SIP requests between the P-CSCF node 124 and the respective S-CSCF node 128.

The HSS 132 is typically a master user database that supports the IMS network nodes that handle the calls/sessions. It contains user profiles, performs authentication and authorization of the user, and can provide information about the physical location of a user. A user profile may be associated with each UE 102 and may contain information about the current user. Such information may be downloaded by the S-CSCF assigned to the user when the user is registered on the network. The S-CSCF may typically receive that information in a User-data Attribute Value Pair (AVP) format. The HSS includes a database of subscriber information and user authentication details, as well as information for use in configuring calls and IP sessions. Multiple HSS nodes can optionally be synchronized to ensure proper cooperation and consistent function.

In operation, a UE 102 interacting with the architecture 100 may initially access the cellular network via access network 104 (1) using 5G technology standards. Through this interaction, the UE 102 may be registered with a PDN, such as the IMS network 108. Notably, the IMS network 108 may not be collocated with the UE 102. For example, the UE 102 may be registered with an IMS network 108 that is not geographically proximate to the UE 102.

During operation, the UE 102 may become disconnected from the access network 104 (1). In such a scenario, the UE 102 may attempt to reestablish its connection with the cellular network via the access network 104 (2), using 4G (LTE) technology standards. In such cases, the PCN 106 may need to assign a PGW and SGW to service the UE 102. In such cases, the AMF 110 provides context data to the MME via a connection 138 (e.g., an N26 connection) that allows the MME to select both a PGW and a SGW that are collocated with the UE 102. For example, the context data may include a list of one or more data networks (e.g., PDNs) that are currently active for the UE 102. The context for each data network may include details such as PGW fully qualified domain name (FQDN), PWG S5/S8 IP, bearer context, and/or so forth. In some cases, the context data may include an indication of a location associated with each of a number of available gateway devices. Additionally, or alternatively, the context data may include information about priority values assigned to each of the gateway devices based on location data for the respective gateway devices.

The network architecture 100 as illustrated in FIG. 1 may be part of a telecommunication network of a wireless service provider such as, T-Mobile, AT&T, Verizon Wireless, etc. The telecommunication network may include one or more PCNs including the PCN 106, one or more IMSs including the IMS network 108, and one or more access networks including the access networks 104(1) and 104(2) and through which a UE 102 can connect to the one or more PDNs.

It should be understood that the network scenario shown in FIG. 1 is for the purpose of illustration. In various real-world scenarios, telecommunication networks or one or more subsystems of a telecommunication network can be logically divided into a number of regions. Each of the regions may logically include a packet core network and an IMS network.

Furthermore, in some examples, each of the DNS 125, the HSS 132, and the TAS 123 may be configured as a centralized component of the telecommunication network accessible to all logically divided IMS networks. Further, although the IMS network 108 as shown in FIG. 1 includes a single P-CSCF node 124, a single S-CSCF node 128, and a single I-CSCF node 126, the IMS network 108 can optionally include multiple P-CSCF nodes, S-CSCF nodes, and I-CSCF nodes.

The techniques discussed herein may be implemented in the telecommunication network using one or more of protocols including but are not limited to Ethernet, 3G, 4G, 4G LTE, 5G, or any combination thereof. The techniques may also optionally be implemented in the telecommunication network using 6G and/or future radio access technologies.

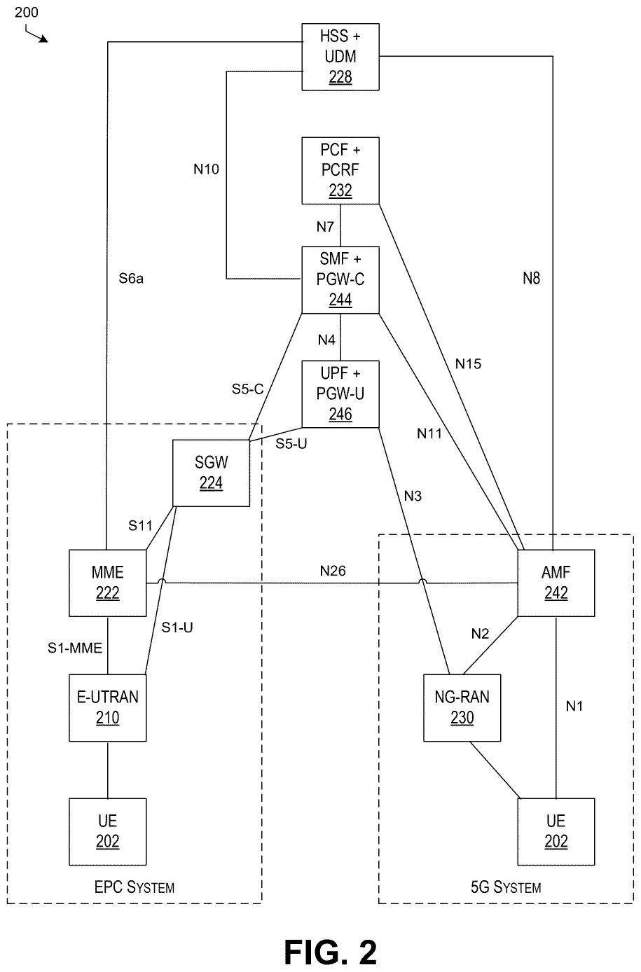

FIG. 2 illustrates a cellular network that includes a combined communication system in accordance with some embodiments. More particularly, the cellular network 200 is capable of servicing one or more UE 202 using either a 4G technology standard or a 5G technology standard. The cellular network 200 may include a UE 202 in communication with the E-UTRAN (eNB) 210 and a NG-RAN (gNB) 230. The gNB may be a standalone gNB or a non-standalone gNB, e.g., operating in Dual Connectivity (DC) mode as a booster controlled by the eNB 210 through an X2 interface. The gNB 230 may, for example, provide additional capacity within a predetermined area inside the eNB 210.

The eNB 210 may be connected with an MME 222 through an S1 interface and with a SGW 224 through an S1-U interface. The MME 222 may be connected with an HSS 228 through an S6a interface while the UDM is connected to the AMF 242 through the N8 interface. The SGW 224 may be connected with the PGW 226 through an S5 interface (control plane PGW-C through S5-C and user plane PGW-U through S5-U). The PGW 226 may serve as an IP anchor for data through the internet.

The system, as above, may contain an AMF 242, Session Management Function (SMF) 244 and User Plane Function (UPF) 246, among others. The eNB 210 and gNB 230 may communicate data with the SGW 224 and the UPF 246. The MME 222 and the AMF 242 may be connected via the N26 interface to provide control information there between.

This may permit mobility interoperability in both the connected state (e.g., handover) and idle state (e.g., cell selection) as well as other types of interoperability, such as load balancing. The use of the N26 interface may also permit the UE context to be exchanged between the 5G system components and the EPC (LTE) system components when the UE is capable of single common registration (registration with the 5G or the 4G access networks) rather than dual registration (with the 5G and the 4G access networks). When the UE 202 is capable of dual registration, transfer of the UE context between the 5G system components and the EPC system components may be avoided as the UE 202 may determine which network to use. The PCF and PCRF 232 may be combined and connected to the AMF 242 through the N15 interface.

In more detail, when the UE 202 is in single registration mode the UE 202 may have a single mobility management state. This state may be the EPS Mobility Management (EMM)-REGISTERED or DE-REGISTERED state in the EPC system or the Registration Management (RM)-REGISTERED or DE-REGISTERED state in the 5G system. The UE 202 may be in the EPC/5G NAS mode, dependent on the CN.

In some cases, the UE 202 is in idle mode, and the N26 interface is supported by the EPC system. In this case, when the UE 202 is being transferred from the 5G system to the EPC system, the AMF 242 may transfer the mobility management context to the MME 222 when the UE enters the EPC network from the 5G system. In the opposite case, the MME 222 may transfer the Single Network Slice Selection Assistance Information (S-NSSAI) associated with the PDN connections and mapping info to the AMF 242. When the N26 interface is not supported, the UE 202 may report the S-NSSAI received from the PGW 226 or SMF 244 to the MME 222 or the AMF 242.

In some cases, the UE is in connected mode, and the N26 interface is supported by the EPC system. In this case, when the UE 202 is being transferred from the 5G system to the EPC system, the AMF 242 may select a target MME 222 and transfer the UE context over the N26 interface. After successful handover from the AMF 242 to the MME 222, a tracking area update may be performed. When the UE 202 is being transferred from the EPC system to the 5G system, the MME 222 may select the target AMF 242 based on the target location and transfer the UE context over the N26 interface. The PGW 226 may send the PDU Session IDs and related S-NSSAIs to the AMF 242. After successful handover, registration may be performed to secure the allowed N-SSAI.

In dual-registration mode, the UE 202 may be able to register with either or both the 5G system and EPC system. For mobility in dual-registration mode, support of the N26 interface may be avoided while in single-registration mode, either the N26 interface may or may not be used. Without the N26 interface, IP address continuity may be provided by storing and fetching information in the PGW-C+SMF and corresponding APN/DDN information via the HSS. In such networks, AMF may also provide an indication that interworking without the N26 interface is supported to UEs during initial 5G registration or the MME may provide an indication that interworking without the N26 interface is supported in the Attach procedure.

During an intersystem change between the 5G system and the EPC system with the N26 interface, the new core network (EPC or 5G) to which the UE is being transferred receives context data from the old core network. Upon receiving the context data, the new core network may generate and populate a priority table based on that context data. For example, if a user equipment switches from operating on an access network having a 5G system to an access network having an LTE system, the MME 222 of the LTE system may receive context data from the AMF 242 of the 5G system over the N26 interface. The MME 222 may then generate a priority table that is populated with values based on that context data. The MME then selects an appropriate gateway device to be assigned to the user equipment based on the requested access.

In embodiments, the priority data is generated based on locations of respective gateway devices with respect to the user equipment. In some cases, the gateway device may be selected based on an alignment between one or more services/capabilities of the respective gateway device and services/capabilities utilized by the user equipment.

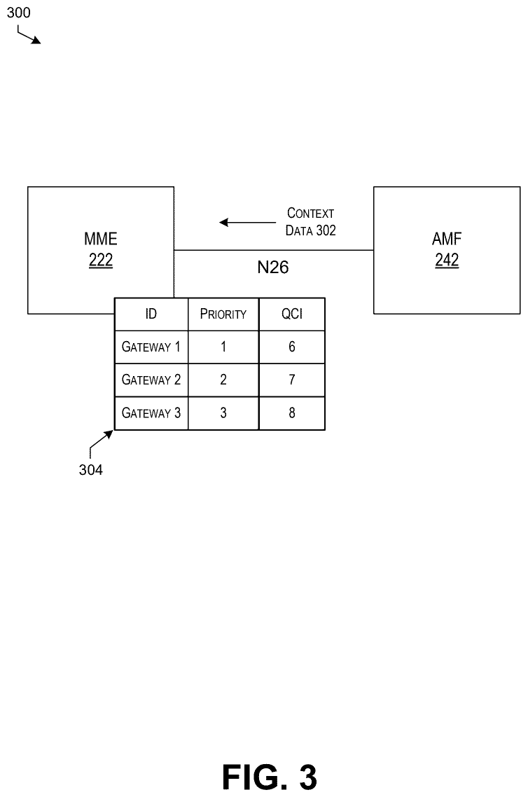

FIG. 3 depicts a block diagram illustrating a process for generating priority data and assigning a gateway device based on that priority data in accordance with embodiments. In embodiments, the process 300 may involve interactions between various components as described elsewhere, such as an MME 222 as operating in an EPC (e.g., LTE) system and an AMF 242 as operating in an 5G system. In such cases, interactions between the MME 222 and AMF 242 occur over an N26 interface.

In some cases, a UE may be switched from a first access network (e.g., 5G) to a second access network (e.g., PCN) in a process known as Inter-RAT Handover or NR-to-LTE handover. In such cases, the network needs to handle the transition smoothly to ensure uninterrupted service. The selection of gateways and routing of traffic in this scenario is more complex than in a standard LTE-only network because the UE is transitioning from one Radio Access Technology (RAT) to another.

The handover from 5G to LTE typically happens when the UE moves out of the 5G coverage area or when the 5G network cannot provide the necessary service (e.g., due to signal degradation or network congestion). In the case of Non-Standalone (NSA) 5G deployment, the UE may already have an active LTE connection for the control plane, while the data plane is supported by the 5G network. When the 5G network becomes unavailable, the LTE network must take over the data traffic as well.

In these cases, the MME 222 receives context data 302 from the AMF 242 over the N26 interface. The MME 222 then generates priority data 304 from that context data 302 that will be used to select an appropriate gateway device (e.g., SGW). In some embodiments, the priority data 304 may include a priority value as well as a Quality of Service (QoS) Class Identifier (QCI) value for each available gateway device. In such cases, the available gateway devices may be assigned a priority value based on a respective distance between that gateway and the UE, with the closest gateway receiving the highest priority. Additionally, the QCI value may be used to represent the level of QoS that can be provided by each of the respective gateway devices.

Once the priority data 304 has been generated, the MME 222 may select a gateway from that priority data 304 based on QoS requirements associated with UE's request to access the network. For example, the MME 222 may traverse the priority data in order based on priority until a gateway device is identified as having a QCI sufficient to meet the QoS requirements associated with the UE. That gateway device (e.g., SGW) is then selected by the MME 222 to be assigned to the UE.

In some cases, the MME 222 may be operated by a third party that is not directly affiliated with the cellular network. In such cases, it may not be possible to have the MME 222 modified to generate the priority data 304 as described above. Hence, in such cases, the priority data 304 may be generated by, and stored on, the AMF 242, which may then provide a selection of the appropriate gateway device to the MME 222 as context data 302. Alternatively, the AMF 242 may provide the priority data 304 as an ordered list within the context data 302 so that the MME 222 selects the highest priority gateway device automatically.

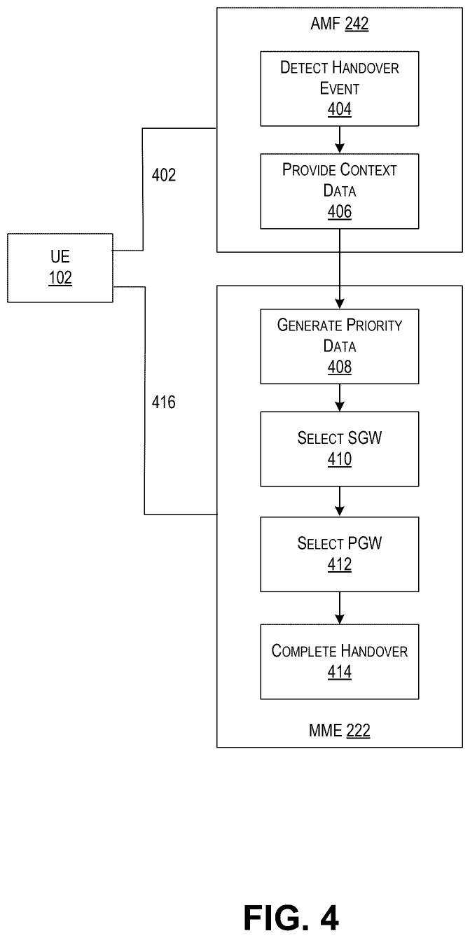

FIG. 4 depicts a block diagram illustrating a process for performing a handover between access networks for a UE in accordance with embodiments. As noted above, a UE may be switched from a first access network (e.g., 5G) to a second access network (e.g., PCN) in some cases, such as when the UE moves out of the 5G coverage area or when the 5G network cannot provide the necessary service.

In embodiments, an initial connection 402 may be maintained between the UE 102 and the AMF 242. The AMF 242 may make a determination at 404 that a handover event needs to take place. In some cases, since the AMF 242 in the 5G core network manages the mobility of the UE, the AMF 242 may detect that the UE is moving out of 5G coverage. Alternatively, the AMF 242 may receive a request from the UE to perform a service that the AMF 242 is unable to provide. Upon detecting the handover event at 404, the AMF 242 will inform a SMF (Session Management Function) to start the process of re-establishing the connection in the LTE network. In some cases, the UE 102 initiates the switch from 5G to LTE by performing an attach procedure in the LTE network. For example, the UE 102 may send an Attach Request to the MME 222 to initiate the switch.

Once a handover has been initiated via a communication with the SMF, the AMF 242 may provide context data to the MME 222 at 406. The MME 222 of the LTE network will then be responsible for handling the UE's attachment to that LTE network, which will require coordination between the AMF 242 and the MME 222 via the N26 interface.

Upon receiving information about a handover to occur, the MME 222 may generate priority data at 408 from context data received at step 406. In embodiments, the priority data may be formatted as a table that includes a priority value as well as a QCI value for each available gateway.

As noted elsewhere, the MME 222 may make a selection of a gateway device based on identifying the gateway device (SGW) at 410 as being the one having the highest priority level while being capable of meeting the QoS requirements of the UE (e.g., as determined based on the respective QCI value).

Once the MME 222 has selected a SGW as illustrated above, the MME 222 may then select a PGW based on operator policies and network configurations at 412. The PGW may be selected such that it is collocated (e.g., physically located within a predetermined distance of the SGW) with the SGW.

Once the MME 222 has selected the SGW and PGW, the handover may be completed at 414. To do this, the necessary bearers (data paths) are established between the eNodeB (LTE base station), the SGW, and the PGW. The MME 222 and SGW work together to set up the bearers (default and/or dedicated) for the UE, ensuring that the appropriate QoS parameters are applied.

After the handover, the UE will start sending and receiving data over the LTE bearers via a new connection 416. The SGW forwards the data to the PGW, which then handles routing the traffic to the external network. The data traffic is no longer routed through the 5G core's UPF, but instead, it follows the usual LTE data path through the SGW and PGW.

Once the handover is complete and the UE is fully connected to the LTE network, the 5G core resources (e.g., the UPF) are deallocated for the UE. The SMF in the 5G core network coordinates the release of the 5G session, and the UE's IP address may be retained (depending on the configuration) or a new IP address may be assigned based on the LTE network's configuration.

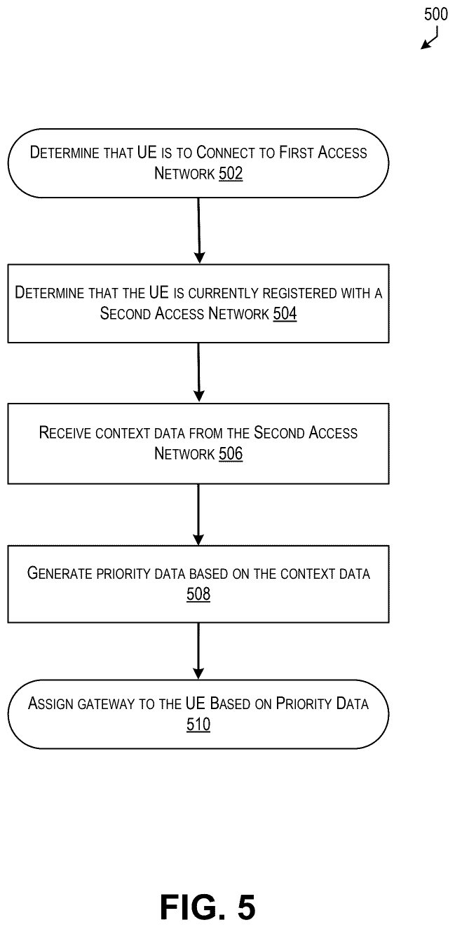

FIG. 5 depicts a flow diagram illustrating an exemplary process for performing gateway selection during a handover event in accordance with at least some embodiments. The process 500 may be performed by a mobility management entity (MME), such as the MME 120 as described in relation to FIG. 1 above.

At 502, the process 500 may involve making a determination that a user equipment is to be connected to a first access network. In some embodiments, determining that the user equipment is to be connected to the first network is based on determining that the user equipment is unable to access the second network. In some embodiments, determining that the user equipment is to be connected to the first network is based on determining that the user equipment is requesting access to a service that is not available on the second network. In some cases, determining that a user equipment is to connect to a first access network comprises receiving an attach request from the user equipment.

At 504, the process 500 may involve making a determination that the user equipment is currently registered with a second access network. For example, a determination may be made that the user equipment is currently registered with a data network (e.g., a PDN), such as an IMS network, that had previously been accessed by the user equipment over the access network that the user equipment is switching away from.

At 506, the process 500 may involve receiving, by the first access network, context data related to the user equipment from the second access network. The context data may include an indication of one or more priority values to be assigned to each of a number of gateway devices. The priority values may be determined for each respective gateway device based on a proximity of the respective gateway device to the user equipment. In some embodiments, the context data is received as a list that is ordered based on at least one priority value.

At 508, the process 500 may involve generating priority data based on the received context data. In some embodiments, the priority data includes at least an indication of a priority value and a Quality of Service (QoS) Class Identifier (QCI) value associated with one or more gateway devices. In some cases, the priority value is generated based on a first location of the respective one or more gateway devices with respect to a second location associated with the user equipment. For example, the gateway devices that is located closest to the user equipment may be assigned the highest priority value.

At 510, the process 500 may involve assigning a gateway device to the user equipment based on the generated priority data. In some embodiments, the gateway device is selected from the one or more gateway devices based on having a highest priority value of the one or more gateway devices that has a QCI value sufficient to satisfy a QoS requirement for the UE. In some embodiments, assigning the gateway device to the user equipment comprises configuring at least one of a serving gateway (SGW) or packet gateway (PGW) to be accessible by the user equipment.

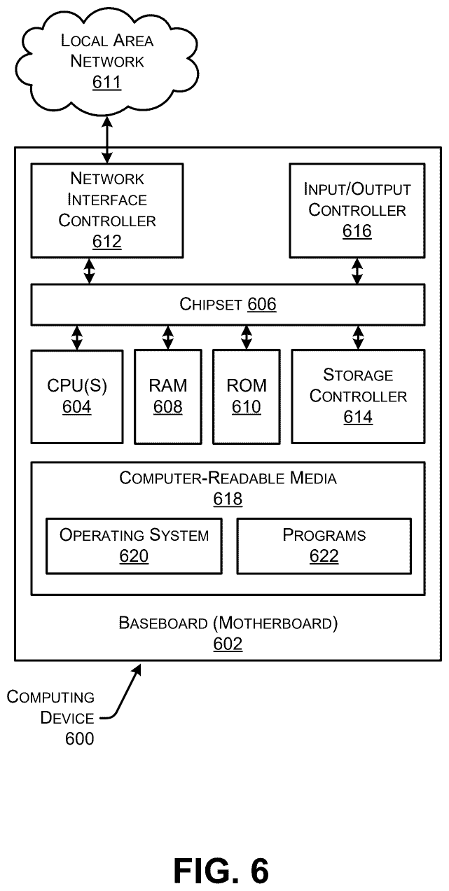

FIG. 6 shows an example computer architecture for a computing device 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 600 may, in some examples, correspond to a physical server as described herein, and may comprise networked devices such as servers, switches, routers, hubs, bridges, gateways, modems, repeaters, access points, etc.

The computing device 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network, such as the network 611. The chipset 606 can include functionality for providing network connectivity through a NIC 612, such as a gigabit Ethernet adapter. The NIC 612 is capable of connecting the computing device 600 to other computing devices over the network 611. It should be appreciated that multiple NICs 612 can be present in the computing device 600, connecting the computer to other types of networks and remote computer systems.

The computing device 600 can be connected to a storage device 618 that provides non-volatile storage for the computer. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by devices as described herein may be supported by one or more devices similar to computing device 600. Stated otherwise, some or all of the operations performed by an edge device, and/or any components included therein, may be performed by one or more computer device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to the other figures. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

As described herein, the computing device 600 may include one or more hardware processors (e.g., CPU 604) configured to execute one or more stored instructions. The processor(s) may comprise one or more cores. Further, the computing device 600 may include one or more network interfaces configured to provide communications between the computing device 600 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 611. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 622 may comprise any type of programs or processes to perform the techniques described in this disclosure. The programs 622 may comprise any type of program that cause the computing device 600 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause computing device 600 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
determining, by a Mobility Management Engine (MME) of a first access network, that a user equipment is to connect to the first access network;
determining, by the MME, that the user equipment is currently registered with a second access network;
receiving, by the MME from the second access network, context data related to a current registration of the user equipment;
generating, by the MME, priority data based on the context data; and
assigning, by the MME to the user equipment, a gateway device selected based on the priority data.

2. The method of claim 1, wherein the priority data comprises an indication of a priority value and a Quality of Service (QoS) Class Identifier (QCI) value associated with one or more gateway devices.

3. The method of claim 2, wherein the gateway device is selected from the one or more gateway devices based on having a highest priority value of the one or more gateway devices that has a QCI value sufficient to satisfy a QoS requirement for the user equipment.

4. The method of claim 2, wherein the priority value is generated based on a first location of the respective one or more gateway devices with respect to a second location associated with the user equipment.

5. The method of claim 1, wherein the context data is received as a list that is ordered based on at least one priority values associated with one or more gateway devices associated with the user equipment.

6. The method of claim 1, wherein assigning the gateway device to the user equipment comprises configuring at least one of a serving gateway (SGW) or packet gateway (PGW) to be accessible by the user equipment.

7. The method of claim 1, wherein determining that the user equipment is to be connected to the first network comprises determining that the user equipment is unable to access the second network.

8. The method of claim 1, wherein determining that the user equipment is to be connected to the first network comprises determining that the user equipment is requesting access to a service that is not available on the second network.

9. The method of claim 1, wherein determining that a user equipment is to connect to a first access network comprises receiving an attach request from the user equipment.

10. A Mobility Management Engine (MME) computing device comprising:
one or more processors; and
one or more non-transitory computer-readable media storing computer-executable instructions that, when executed by the one or more processors, cause computing device to perform operations comprising:
determining that a user equipment is to connect to a first access network;
determining that the user equipment is currently registered with a second access network;
receiving, from the second access network, context data related to a current registration of the user equipment;
generating priority data based on the context data; and
assigning, to the user equipment, a gateway device selected based on the priority data.

11. The MME computing device of claim 10, wherein the priority data comprises an indication of a priority value and a Quality of Service (QoS) Class Identifier (QCI) value associated with one or more gateway devices.

12. The MME computing device of claim 11, wherein the gateway device is selected from the one or more gateway devices based on having a highest priority value of the one or more gateway devices that has a QCI value sufficient to satisfy a QoS requirement for the user equipment.

13. The MME computing device of claim 11, wherein the priority value is generated based on a first location of the respective one or more gateway devices with respect to a second location associated with the user equipment.

14. The MME computing device of claim 10, wherein assigning the gateway device to the user equipment comprises configuring at least one of a serving gateway (SGW) or packet gateway (PGW) to be accessible by the user equipment.

15. The MME computing device of claim 10, wherein determining that the user equipment is to be connected to the first network comprises determining that the user equipment is unable to access the second network.

16. The MME computing device of claim 10, wherein determining that the user equipment is to be connected to the first network comprises determining that the user equipment is requesting access to a service that is not available on the second network.

17. One or more non-transitory computer-readable media storing computer-executable instructions that, when executed by one or more processors, cause the one or more processors to perform operations comprising:
determining that a user equipment to be connected to a first access network is currently registered with a second access network;
receiving, from the second access network, context data related to a current registration of the user equipment;
generating priority data based on the context data; and
assigning, to the user equipment, a gateway device selected based on the priority data.

18. The one or more non-transitory computer-readable media of claim 17, wherein comprise determining that the user equipment is currently registered with a second access network is based on determining that the user equipment is currently registered with a public data network (PDN).

19. The one or more non-transitory computer-readable media of claim 17, further comprising receiving an access request from the user equipment, wherein the determining that the user equipment is to be connected to the first access network is based on receiving the access request.

20. The one or more non-transitory computer-readable media of claim 17, wherein the priority data comprises a table of priority values associated with a set of gateway devices.
